(19) United States
(12) Patent Application Publication
(10) Pub. No.: US 2007/0083684 A1
(43) Pub. Date: Apr. 12, 2007

(54) Data stream converter and data conversion circuit

(76) Inventor: Hiroshi Ueda, Sendai-shi (JP)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/524,365

(22) Filed: Sep. 20, 2006

(30) Foreign Application Priority Data
Sep. 21, 2005 (JP) 2005-273872

(51) Int. Cl. G06F 13/38

(52) U.S. Cl. 710/65

(57) ABSTRACT

A data stream converter for converting a data stream quickly and flexibly with a simple structure. The data stream converter includes control registers for setting search data or replacement data. The search data stored in the control registers is provided to a comparator, which compares the input stream with the search data from the control registers. A command processor provides a replacement timing signal to a shift register and a switch timing signal to a multiplexer. Data replacement in the data stream is performed by the multiplexer. These operations are realized by data stream converters arranged in multiple stages using a match detection signal.

### BACKGROUND OF THE INVENTION

The present invention relates to a data stream converter and a data conversion circuit for converting a data stream.

Various types of data streams that comply with various recommendations and standards are used in networks. Such recommendations and standards, which are established within a short period of time, are frequently updated. For a network device to be able to implement such updates, most of data stream processing undergoes software processing, and such software may be changed to implement new functions. Japanese Laid-Open Patent Publication No. 10-126515 describes a data stream conversion device for a remote communication system that alternately transmits segments of data streams in different formats. The data stream conversion device enables quick and simple connection to terminals of various types of remote communication networks. Alternatively, hardware applicable to only the present recommendation or standard may be used.

When performing a function in accordance with a certain protocol in a network device, hardware conforming to the protocol is often installed in the network device to achieve higher throughput. However, such hardware is designed to function in accordance with a specific protocol and is thus not versatile. Therefore, such hardware may not comply with any new protocols.

Further, when a function is realized through software, software may be changed to comply with a new protocol standard. However, when software processing is performed, more difficulties arise in high throughput processing as compared to when realizing the function through hardware. In a network device, a large number of data streams must be continuously processed. Thus, software processing must be performed for each processing unit (e.g., frame unit), which increases the load on a processor or a bus.

Additionally, such software processing normally requires a longer operation time than when performing similar hardware processing. This lowers the capability for processing data streams between an input and output of a network device and lowers the throughput.

The development of improved software requires expert knowledge of existing software and usually requires a relatively long time.

### SUMMARY OF THE INVENTION

It is therefore an object of the present invention to provide a data stream converter capable of converting a data stream flexibly and quickly with a simple structure.

One aspect of the present invention is a data stream converter including a shift register for receiving a data stream, a control register for storing a command, a command processor for receiving and outputting a match detection signal, and a multiplexer. The command processor instructs the multiplexer to perform a conversion process, based on the command stored in the control register, on the data stream received by the shift register when receiving the match detection signal from a data stream converter in a preceding stage that is connected to said data stream converter. The multiplexer outputs the converted data stream.

A further aspect of the present invention is a data conversion circuit including a plurality of data stream converters connected to one another by a switching means. Each data stream converter includes a shift register for receiving a data stream, a control register for storing a command, a command processor for receiving and outputting a match detection signal, and a multiplexer. The command processor instructs the multiplexer to perform a conversion process, based on the command stored in the control register, on the data stream received by the shift register when receiving the match detection signal from a data stream converter in a preceding stage that is connected to the associated data stream converter. The multiplexer outputs the converted data stream. The switching means controls connection between the data stream converters in accordance with a setting of an external register.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a circuit diagram showing a preferred embodiment of the present invention;

FIG. 2 is a schematic diagram illustrating the function of a text editor;

FIG. 3 is a schematic diagram illustrating the function of a data stream conversion circuit;

FIG. 4A is a schematic diagram illustrating the detection of a pattern;

FIG. 4B is a schematic diagram illustrating replacement;

FIG. 4C is a schematic diagram illustrating insertion;

FIG. 5 is a schematic diagram of a capsulation circuit for encapsulating a data stream in accordance with an embodiment of the present invention; and

FIG. 6 is a schematic diagram of a decapsulation circuit for unencapsulating a data stream.

### DESCRIPTION OF THE PREFERRED EMBODIMENTS

[Basic Structure of a Data Stream Converter]

FIG. 1 is a circuit diagram showing the basic structure of a data stream converter 10 according to the present invention. The data stream converter 10 includes control registers 12 for setting either one of or both search data and replacement data. The search data may also be used as the insertion data.

The control registers 12 store data for setting a range for searching or replacing data. The control registers 12 further store data used for setting a data mask for the search data that is used for detecting partial matching data portions.

The settings are used to control a shift register 11 of the data stream converter 10. The shift register 11 has a capacity that is sufficient for holding the search data or the replacement data, whichever has a greater data amount. The shift register 11 may be realized by a delay circuit.

The search data stored in the control registers 12 is provided to a comparator 13. The comparator 13 is also provided with input stream, which is stored in the shift register 11. Then, the comparator 13 compares the input stream and the search data, which is provided from the control registers 12.

Further, the data stream converter 10 includes a counter 14. The counter 14, which counts the number of bytes or bits in the input stream, is used for detecting the head and the end of data. The unit for performing counting is not limited as long as data positions may be located. Also, the counter 14 receives a stream enable signal, which is synchronized with the input stream, via a circuit multistage connection input interface. Further, the counter 14 may be used to measure the data amount in the data stream. The counting result of the counter 14 is used to locate a bit.

The data stream converter 10 further includes a command processor 15, which receives signals from the control registers 12, the comparator 13, and the counter 14. The command processor 15 also receives a match detection signal from another data stream converter 10 via the circuit multistage connection input interface. The command processor 15 provides a replacement timing signal to the shift register 11 and a switch timing signal to a multiplexer 16. Further, the command processor 15 outputs the match detection signal and the stream enable signal, which are supplied to another data stream converter 10, via the circuit multistage connection output interface.

Data replacement or the like in a data stream is performed by the multiplexer 16. Specifically, the counter 14 synchronizes the data detected by the comparator 13 with the replacement data, which is provided from the control registers 12. The multiplexer 16 uses the replacement data to perform data replacement. The multiplexer 16 may have any circuit structure.

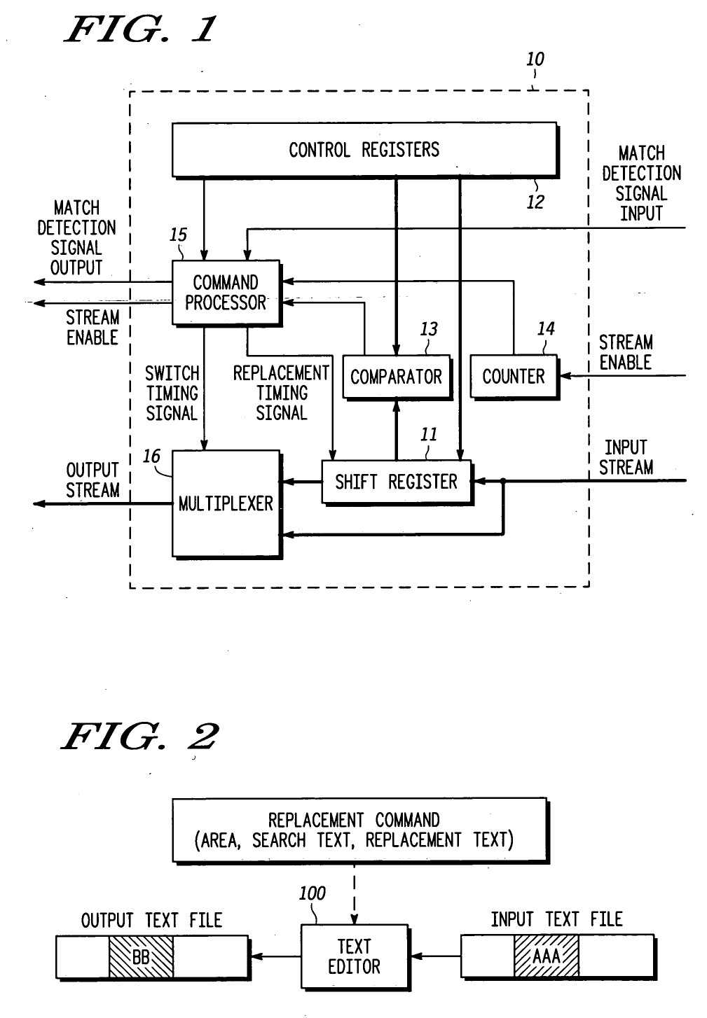

FIG. 2 shows an example of conversion of a designated text within a specific area of a text file in a text editor 100. The text editor 100 performs a pattern search and conversion on an input text file based on a replacement command, which includes an area, a search text, and a replacement text. Since this function is simple, flexible and versatile conversion may be performed.

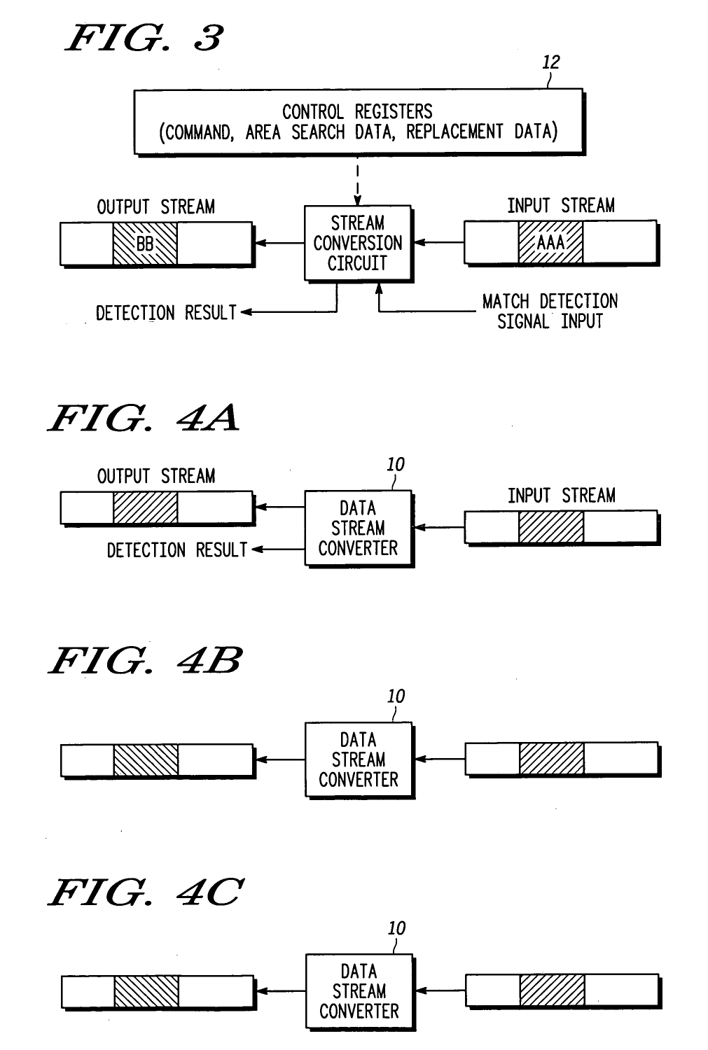

The data stream converter 10 also serves as a network device data stream conversion circuit, which includes the functions of a typical text editor that realizes a simple and versatile data search function, data location detection function, and data replacement function through hardware, as shown in FIG. 3. Specifically, in the same manner as the text editor, the data stream conversion circuit of the data stream converter 10 (i.e., shift register 11, control registers 12, comparator 13, counter 14, command processor 15, and multiplexer 16) generates an output stream based on a command, area, search data, and replacement data, which is set by the control registers 12 for the input stream. Further, the data stream conversion circuit receives the match detection signal and outputs the detection results (i.e., match detection signal etc.).

Next, a circuit for having a data stream (frame, packet, or the like), which is used in network hardware, comply with a predetermined protocol will now be described. For example, when a predetermined pattern is detected at a predetermined position of an input stream as shown in FIG. 4A, the detection result may be output. In this case, the pattern that is to be detected is stored in the set of control registers 12 and undergoes comparison by the comparator 13. Then, the position of the pattern in this state is detected by the counter 14. Thereafter, the results related to the detected pattern and detected position are output.

Also, when a predetermined pattern is detected in the input stream, the pattern is replaced or deleted, as shown in FIG. 4B.

Further, when a predetermined pattern is detected in an input stream, the predetermined pattern is inserted, as shown in FIG. 4C.

By combining these operations, it is possible to carry out conversion, inverted conversion, or recognition of a data stream in compliance with a protocol.

[Capsulation and Decapsulation of a Data Stream]

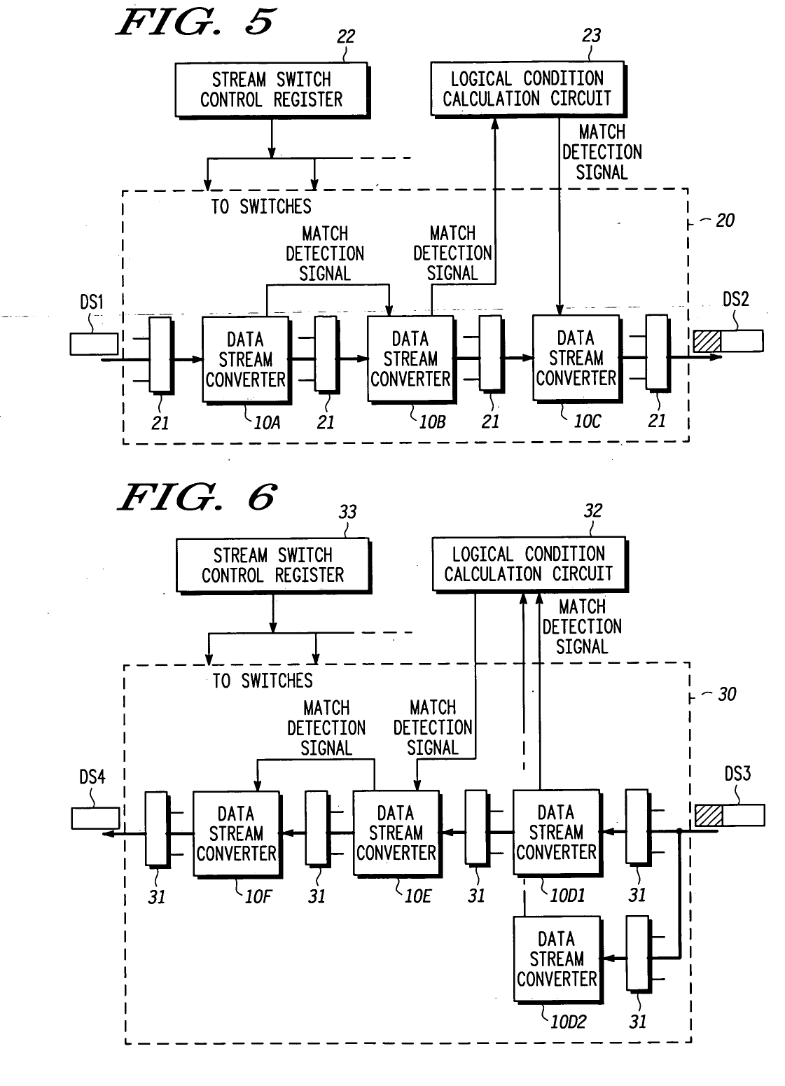

Next, an example of capsulation and decapsulation of a data stream in compliance with a predetermined protocol will be described. FIG. 5 shows an example of a capsulation circuit 20 for capsulating a data stream, and FIG. 6 shows an example of a decapsulation circuit 30 for decapsulating a data stream.

The capsulation circuit 20 shown in FIG. 5 receives a data stream DS1, which is not capsulated from the left side, and outputs a data stream DS2, which is capsulated from the right side. The decapsulation circuit 30 shown in FIG. 6 receives a data stream DS3, which is capsulated from the right side, and a data stream DS4, which is not capsulated from the left side.

First, capsulation will be described with reference to FIG. 5. The capsulation circuit 20 employs a plurality of (three) data stream converters 10A, 10B, and 10C. The data stream converters 10A, 10B, and 10C are connected to one another by switches 21, which serve as switching means. Each switch 21 is controlled by a stream switch control register 22 arranged outside the capsulation circuit 20. The switches 21 control inputs to the data stream converters 10A, 10B, and 10C. The data stream converters 10A, 10B, and 10C operate independently from one another in accordance with the settings of the control registers 12 in the circuit.

In the capsulation sequence example of FIG. 5, the three data stream converters 10A, 10B, and 10C respectively perform pattern detection, data delaying, and pattern insertion. Such combination of the data stream converters 10 is set by the stream switch control register 22.

Specifically, a desired detection pattern is stored in the data stream converter 10A. When the data stream DS1, which matches the desired pattern, is detected, the data stream converter 10A provides a match detection signal to the data stream converter 10B. In this case, the data stream converter 10B performs a delaying process. This adjusts the timing so that the operation of the data stream converter 10C may be followed. Then, the data stream converter 10B provides a match detection signal to a condition calculation circuit 23. The condition calculation circuit 23 instructs the data stream converter 10C to perform pattern insertion. As a result, the data stream converter 10C outputs a capsulated data stream DS2.

Next, decapsulation will be described with reference to FIG. 6. The decapsulation circuit 30 employs a plurality of (four) of data stream converters 10D1, 10D21, 10E, and 10F. The data stream converters 10D1, 10D2, 10E, and 10F are connected to one another via switches 31, which serve as switching means in the decapsulation circuit 30. Each switch 31 is controlled by an external register (stream switch control register 33) arranged outside the decapsulation circuit 30. Inputs to the data stream converters 10D1, 10D2, 10E, and 10F are controlled by the switches 31. The data stream converters 10D1, 10D2, 10E, and 10F operate independently from one another in accordance with the settings of the control registers in the circuit.

In the decapsulation sequence of FIG. 6, the data stream converters 10D1 and 10D2 perform pattern detection, the data stream converter 10E performs data delaying, and the data stream converter 10F performs pattern replacement. Specifically, a desired detection pattern is stored in the data stream converters 10D1 and 10D2. The plurality of data streams 10D1 and 10D2 are used to perform a plurality of comparisons during pattern detection. When the desired pattern stored in the corresponding control register 12 is detected in the data stream DS3, each data stream converter 10D1 and 10D2 provides a match detection signal to a logical condition calculation circuit 32 arranged outside the data stream converters. The logical condition calculation circuit 32 performs a calculation using the match detection signal from the data stream converters 10D1 and 10D2 to realize complicated pattern detection. Then, the logical condition calculation circuit 32 provides the match detection signal to the data stream converter 10E, which is in a subsequent stage.

The data stream converter 10E performs a delaying process based on the match detection signal from the logical condition calculation circuit 32. Then, the data stream converter 10E provides the match detection signal to the data stream converter 10F. The data stream converter 10F performs pattern deletion and outputs the decapsulated data stream DS4. As a result, decapsulation is realized when a specific portion of a data stream is deleted under the condition that compared patterns match each other.

The present embodiment of the present invention has the advantages described below.

In the present embodiment, the search data stored in the control registers 12 is provided to the comparator 13, which is also provided with the input stream stored in the shift register 11. The comparator 13 compares the input stream with the search data provided from the control registers 12. The command processor 15 provides a replacement timing signal to the shift register 11 and a switch timing signal to the multiplexer 16. The multiplexer 16 performs data replacement or the like in a data stream. Therefore, data stream converter 10 functions as a network device data stream conversion circuit, which includes the functions of a typical text editor that realizes a simple and versatile data search function, data location detection function, and data replacement function through hardware. This enables application to a new protocol without changing a circuit and realizes flexibility and easy operation of software in addition to high-speed processing with hardware.

In the present embodiment, the data stream converter 10 includes the command processor 15, which receives signals from the control registers 12, the comparator 13, and the counter 14. The command processor 15 receives a match detection signal from another data stream converter 10 via the circuit multistage connection input interface. Then, the command processor 15 provides the replacement timing signal to the shift register 11 and the switch timing signal to the multiplexer 16. Further, the command processor 15 outputs the match detection signal or the stream enable signal, which are to be provided to another data stream converter 10, via the circuit multistage connection output interface. This enables multistage connection with a plurality of data stream converters. Therefore, highly advanced conversion of a data stream may be performed, and function expansion may be realized.

In the present embodiment, the data stream converter 10 includes the counter 14. The counter 14 counts the number of bytes and bits in the input stream and detects the head and end of data. This enables the detection of the head and end of the input stream to be notified to another data stream converter 10, which performs conversion.

It should be apparent to those skilled in the art that the present invention may be embodied in many other specific forms without departing from the spirit or scope of the invention. Particularly, it should be understood that the present invention may be embodied in the following forms.

In the above embodiment, each data stream converter 10 includes the comparator 13 and the counter 14. However, either the comparator 13 or the counter 14 may be eliminated.

In the above embodiment, conversion of a data stream for a remote communication system, such as capsulation or decapsulation, is performed. However, the present invention is not limited in such a manner.

The present examples and embodiments are to be considered as illustrative and not restrictive, and the invention is not to be limited to the details given herein, but may be modified within the scope and equivalence of the appended claims.

1. A data stream converter comprising:
a shift register for receiving a data stream;
a control register for storing a command;
a command processor for receiving and outputting a match detection signal; and
a multiplexer, wherein;
the command processor instructs the multiplexer to perform a conversion process, based on the command stored in the control register, on the data stream received by the shift register when receiving the match detection signal from a data stream converter in a preceding stage that is connected to said data stream converter; and
the multiplexer outputs the converted data stream.

2. The data stream converter according to claim 1, wherein the control register further stores search data, the data stream converter further comprising:
a comparing means for comparing data, wherein the comparing means compares the data stream received by the shift register with the search data stored in the control register and notifies the command processor of a match detection when detecting a match; and
wherein the command processor provides the match detection signal to a data stream converter in a subsequent stage that is connected to said data stream converter.

3. The data steam converter according to claim 1, further comprising:
a counter for counting a data position in the received data stream, wherein the data position at which a match is detected is output together with the match detection signal.

4. The data stream converter according to claim 1, wherein:
the control register further stores replacement data; and
the command processor acquires the replacement data stored in the control register when the command processor receives the match detection signal and outputs to the multiplexer a switch timing signal for replacing the search data, which is included in the data stream received by the shift register, with the replacement data.

5. The data stream converter according claim 1, wherein the command processor outputs to the multiplexer a switch timing signal for deleting the search data, which is included in the data stream received by the shift register, based on the command stored in the control register when the command processor receives the match detection signal.

6. The data stream converter according to claim 1, wherein the control register further stores insertion data, and the command processor outputs to the multiplexer a switch timing signal for inserting the insertion data in the search data, which is included in the data stream received by the shift register, based on the command stored in the control register when the command processor receives the match detection signal.

7. A data conversion circuit comprising:
a plurality of data stream converters connected to one another by a switching means, each data stream converter including:
a shift register for receiving a data stream;
a control register for storing a command;
a command processor for receiving and outputting a match detection signal; and
a multiplexer, wherein;
the command processor instructs the multiplexer to perform a conversion process, based on the command stored in the control register, on the data stream received by the shift register when receiving the match detection signal from a data stream converter in a preceding stage that is connected to the associated data stream converter;
the multiplexer outputs the converted data stream; and
the switching means controls connection between the data stream converters in accordance with a setting of an external register.
